(19) United States
(12) Patent Application Publication
(10) Pub. No.: US 2018/0241263 A1
(43) Pub. Date: Aug. 23, 2018

(54) A RING MAGNET UNIT FOR AN ELECTRIC MOTOR

(71) Applicant: NIDEC MOTORS & ACTUATORS (GERMANY) GMBH, Bietigheim-Bissingen (DE)

(72) Inventor: Juergen SCHMID, Bietigheim-Bissingen (DE)

(73) Assignee: NIDEC MOTORS & ACTUATORS (GERMANY) GMBH, Bietigheim-Bissingen (DE)

(21) Appl. No.: 15/769,761

(22) PCT Filed: Oct. 21, 2016
(86) PCT No.: PCT/JP2016/081256

§ 371 Date: Apr. 20, 2018

(30) Foreign Application Priority Data
Oct. 21, 2015 (DE) 10 2015 013 690.9

(51) Int. Cl. H02K 1/27

(52) U.S. Cl. CPC H02K 1/2733; H02K 29/03; H02K 2201/06

(57) ABSTRACT

A ring magnet unit for an electric motor is provided, comprising a circular magnet holder and at least two magnet segments fixed to the magnet holder and arranged in a circumferential direction of the magnet holder, wherein respective one magnet segment has a first surface abutting to a surface of the magnet holder and a second surface which is the opposite surface of the first surface. Both side surfaces of the first surface and the second surface are chamfered in the directions that cross the radial direction of the magnet holder at the same angles. At least one pair of the adjacent two magnet segments comprises one magnet segment whose circumferential length of the first surface is equal to or longer than the circumferential length of the second surface and the other magnet segment whose circumferential length of the first surface is equal to or shorter than the circumferential length of the second surface.

### BACKGROUND OF THE INVENTION

### 1. Field of the Invention

The invention refers to a ring magnet unit and an electric motor therewith. Specifically, the invention refers to a ring magnet unit comprising plural magnet segments and plural magnetic fields.

### 2. Description of the Related Art

In brushed motors normally single ferrite magnets or low grade ring magnets, for example plastic bonded neodymium, ring magnets are used and in brushless motors usually a rotor built with low grade ring magnets is used. One example of a ring magnet having outer polygonal shape is disclosed in US 2010/102662 A1. Furthermore, attempts have been made to build up electrical motors by arranging magnet segments to build up a ring like shape, wherein gaps are at least partly arranged in the magnet segments in a circumferential direction. DE 3 521 005 A1 discloses a motor having four segments, arranged in mutually abutting pairs, gaps being arranged between said pairs.

### SUMMARY OF THE INVENTION

An object of the invention is to achieve a highly efficient magnetic circuit in a simple and inexpensive manner. A further object of the invention is to increase the power of electric motors without increasing their length while reducing the cogging torque in a simple and inexpensive manner.

According to a first aspect of the invention, a ring magnet unit for an electric motor is provided, comprising a circular magnet holder and at least two magnet segments fixed to the magnet holder. Each of the at least two magnet segments is arranged in a circumferential direction of the magnet holder. The respective one magnet segment has a first surface abutting to a surface of the magnet holder and a second surface which is the opposite surface of the first surface and both side surfaces of the first surface and the second surface are chamfered in the directions that cross the radial direction of the magnet holder at the same angles. Such the at least two magnet segments are characterized in that one pair of the adjacent two magnet segments are comprising one magnet segment whose circumferential length of the first surface is equal to or longer than the circumferential length of the second surface and the other magnet segment whose circumferential length of the first surface is equal to or shorter than the circumferential length of the second surface.

The circular magnet holder can form a motor housing or an inner rotor of an inner rotor motor or otherwise the circular magnet holder can also form an outer rotor of an outer rotor motor. When the circular magnet holder is a motor housing or an outer rotor of an outer rotor motor, the at least two magnet segments are fixed to an inner circumferential surface of the circular magnet holder. Moreover, when the circular magnet holder is an inner rotor of an inner rotor motor, the at least two magnet segments are fixed to an outer circumferential surface of the circular magnet holder.

This arrangement enables to increase the effective pole angle (i.e. the circumferential length of each magnetic pole section), whereby the power of the electric motor is increased while keeping the same motor length, because there are no longer big gaps between the magnet segments, which are existing in prior arts. This magnet geometry can achieve the easiest magnet fixture. When fixing a ring magnet to a motor housing, the ring magnet is inserted in the axial direction of the motor housing. For fixing the ring magnet, adhesives are spread on the outer surface of the ring magnet and such adhesives are taken at the time of insertion into the housing because the circumferential length of the housing and the ring magnet are almost the same. Therefore, fixing a ring magnet into a housing securely is difficult. However, this invention can achieve the manner to insert each magnet segment in a radial direction and can set a ring magnet unit securely fixed to the housing. This can be achieved in the manner that the last magnet segment whose circumferential length of the first surface is equal to or shorter than the circumferential length of the second surface are inserted in the radial direction after other magnet segments are inserted in the radial direction.

According to an aspect of the invention, the side surfaces of the adjacent two magnet segments are abutting each other in the circumferential distance. A small gap between the adjacent two magnet segments can be also allowed. Such a gap is sometimes provided because of manufacturing tolerances of magnet segments and the narrowest gap is more preferable.

According to an aspect of the invention, both chamfered side surfaces have at least one stepping portion respectively.

According to an aspect of the invention, at least one field of a north magnetic pole and at least one field of a south magnetic pole are arranged in the circumferential direction one after another on the ring magnet unit.

According to an aspect of the invention, the at least one field of the north magnetic pole and the at least one field of the south magnetic pole are respectively arranged on the ring magnet unit over plural magnet segments (two or three magnet segments). This arrangement enables to increase the effective pole angle (i.e. the circumferential length of each magnetic pole section) regardless of the circumferential length of each magnet segment, whereby the power of the electric motor is increased while keeping the same motor length. Furthermore, this can achieve the flexible magnetic field arrangements without consideration of the geometry of magnet segments by magnetizing the ring magnet unit in the desired manner after setting the ring magnet unit in the housing.

According to an aspect of the invention, the circumferential length of the at least one field of the north magnetic pole and the at least one field of the south magnetic pole are different from the circumferential length of other fields. One of the flexible magnetic field arrangement is achieved by different circumferential lengths of magnetic fields. This arrangement can reduce the cogging torque when the lengths of magnetic fields are arranged to be so and can also be used as rotation detection where irregular torque ripple etc. are detected whenever a motor rotates, for example, in a 360 degree.

According to an aspect of the invention, the at least one field of the north magnetic pole is comprising at least two fields and the at least one field of the south magnetic pole is comprising at least two fields and the circumferential length of the at least one gap between the adjacent one field of the north magnetic pole and one field of the south magnetic pole are different from the circumferential length of other gaps. Another flexible magnetic field arrangement is achieved by different circumferential lengths of magnetic fields. This arrangement can also reduce the cogging torque when the lengths of magnetic fields are arranged to be so and can be used as rotation detection where irregular torque ripple etc. are detected whenever a motor rotates, for example, in a 360 degree.

According to an aspect of the invention, the at least one field of the north magnetic pole and the at least one field of the south magnetic pole comprise skewed magnetic fields. This arrangement can also reduce the cogging torque.

According to an aspect of the invention, the skewed magnetic fields are formed to be V-shape or C-shape.

The advantages of the invention of the present disclosure can be summarized as follows:
a. The effective pole angle can be increased.
b. The power of the electric motor can be increased keeping the same motor length. This is especially relevant for electric motors having a discrete ferrite magnet design.
c. The ring magnet unit is easily inserted and securely fixed to the magnet holder.
d. The cogging torque of the electric motor can be reduced as well as the noise.
e. Irregular arrangements of magnetic fields can be used for rotation detection.
f. There is no limit in achievable skew angle for rotors or stators with a low ratio in length to diameter.
g. An electric motor comprising four magnets and poles is not limited to an angle in between the center of the magnetic poles of 90 degrees.

The above and other elements, features, steps, characteristics and advantages of the present invention will become more apparent from the following detailed description of the preferred embodiments with reference to the attached drawings.

### BRIEF DESCRIPTION OF THE DRAWINGS

The invention will now be described on the basis of figures. It will be understood that the embodiments and aspects of the invention described in the figures are only examples and do not limit the protective scope of the claims in any way. The invention is defined by the claims and their equivalents. It will be understood that features of one aspect or embodiment of the invention can be combined with a feature of a different aspect or aspects of other embodiments of the invention. This invention becomes more obvious when reading the following detailed descriptions of some examples as part of the disclosure under consideration of the enclosed drawings, in which:

FIG. 1A is a cross sectional view of a ring magnet unit in accordance with the first embodiment.

FIG. 1B is a cross sectional view of a ring magnet unit of another aspect of the first embodiment.

FIG. 2 is a cross sectional view of a ring magnet unit of further aspect of the first embodiment.

FIG. 3A is a flat view of a ring magnet unit comprising of plural skewed magnetic fields.

FIG. 3B is a flat view of a ring magnet unit comprising of plural skewed magnetic fields with a gap between adjacent two magnetic fields.

FIG. 3C is a flat view of a ring magnet unit comprising of plural skewed magnetic fields in V-shape.

FIG. 3D is a flat view of a ring magnet unit comprising of plural skewed magnetic fields in C-shape with a gap between adjacent two magnetic fields.

FIG. 3E is a flat view of a ring magnet unit comprising of plural perpendicular magnetic fields.

### DETAILED DESCRIPTION OF THE PREFERRED EMBODIMENTS

The object of the present invention is fully described below using examples for the purpose of disclosure, without limiting the disclosure to the examples. The examples present different aspects of the present invention. To implement the present technical teaching, it is not required to implement all of these aspects combined. Rather, a specialist will select and combine those aspects that appear sensible and required for the corresponding application and implementation.

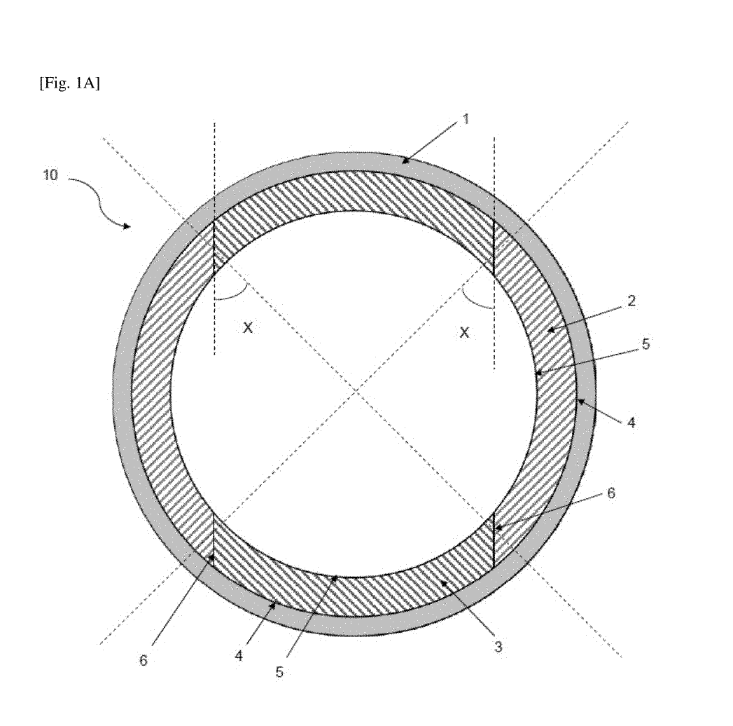

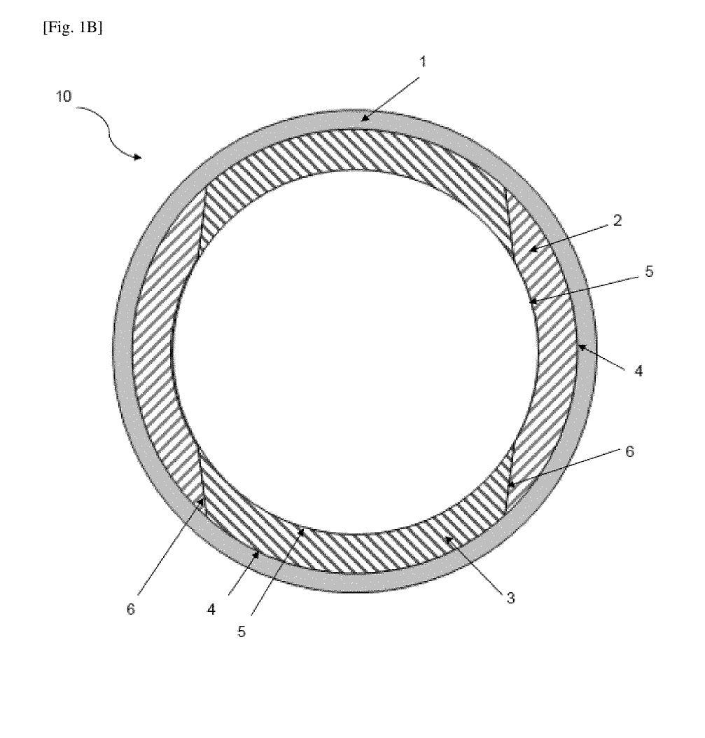

FIG. 1A shows a cross sectional view of a ring magnet unit 10 in accordance with a first embodiment. The ring magnet unit 10 comprises a circular magnet holder 1 and at least two magnet segments 2, 3. FIG. 1A shows a pair of a first magnet segment 2 and a pair of a second magnet segment 3, but the present invention is not limited to this configuration. FIG. 1A shows that the pair of the first magnet segment 2 is fixed to the magnet holder 1 and arranged in a circumferential direction of the magnet holder 1. Respective one magnet segment has a first surface 4 abutting to a surface of the magnet holder 1 and a second surface 5 which is the opposite surface of the first surface 4 and both side surfaces 6 of the first surface 4 and the second surface 5 are chamfered in the directions that crosses the radial direction of the magnet holder 1 at the same angles X. The magnet segments 2, 3 are characterized in that the circumferential length of the first surface 4 of the first magnet segment 2 is equal to or longer than the circumferential length of the second surface 5 and the circumferential length of the first surface 4 of the second magnet segment 3 is equal to or shorter than the circumferential length of the second surface 5.

FIG. 1A shows an example that the circumferential length of the first surface 4 of the first magnet segment 2 is equal to the circumferential length of the second surface 5 and the circumferential length of the first surface 4 of the second magnet segment 3 is equal to the circumferential length of the second surface 5. FIG. 1B shows an example that the circumferential length of the first surface 4 of the first magnet segment 2 is longer than the circumferential length of the second surface 5 and the circumferential length of the first surface 4 of the second magnet segment 3 is shorter than the circumferential length of the second surface 5.

For example, the circular magnet holder 1 can form a motor housing or an inner rotor of an inner rotor motor or otherwise the circular magnet holder 1 can also form an outer rotor of an outer rotor motor. When the circular magnet holder 1 is a motor housing or an outer rotor of an outer rotor motor, the at least two magnet segments 2, 3 are fixed to an inner circumferential surface of the circular magnet holder 1. Moreover, when the circular magnet holder 1 is an inner rotor of an inner rotor motor, the at least two magnet segments 2, 3 are fixed to an outer circumferential surface of the circular magnet holder 1.

In this embodiment, four magnet segments 2, 3 are used, however, more than four and even number of magnet segments are allowed. When the radius of the circular magnet holder 1 is bigger, the ring magnet unit 10 with more than four magnet segments 2, 3 works effectively.

A full or partial gap or open space between adjacent two magnet segments is also allowed. In this case, tolerance of the magnet segments 2, 3 and the magnet holder 1 are absorbed. However, narrower or smaller gap or open space is better and when the side surfaces 6 of the adjacent two magnet segments 2, 3 are abutting each other in the circumferential distance as seen in FIG. 1A, a flux can flow in the most efficient manner.

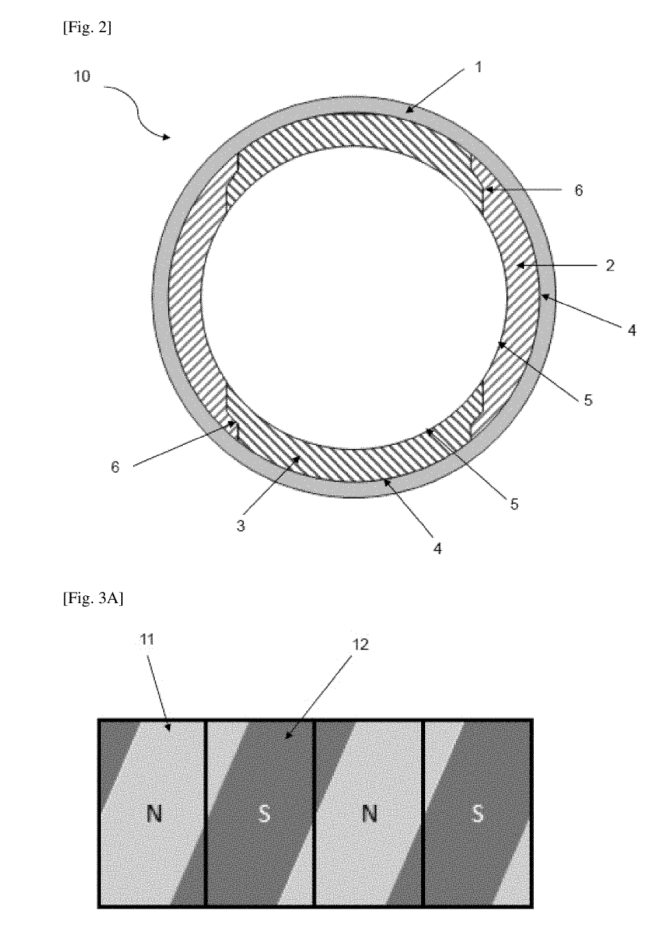

As can be seen in FIG. 2, the chamfered both side surfaces 6 can have at least one stepping portion respectively.

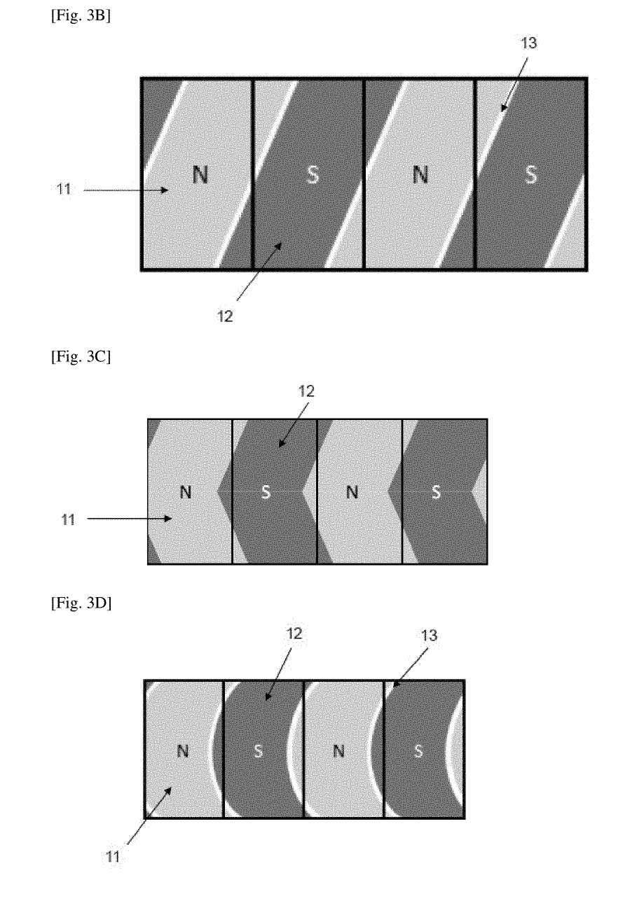

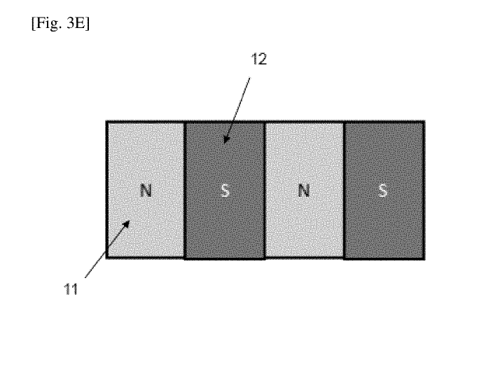

As can be seen in FIG. 3A, at least one field of a north magnetic pole 11 and at least one field of a south magnetic pole 12 are arranged in the circumferential direction one after the other on the ring magnet unit. These magnetic fields are formed by specific tools magnetizing magnetic fields on the magnet segments. This magnetizing process can be executed either before or after the magnet segments 2, 3 are fixed to the magnet holder 1.

The at least one field of the north magnetic pole 11 and the at least one field of the south magnetic pole 12 are respectively arranged on the ring magnet unit 10 overlapping plural magnet segments. In this case, magnetic fields can be accurately formed on the predefined places of the ring magnet unit 10, irrespective to the configurations, positions, and tolerances of magnet segments 2, 3. Furthermore, this arrangement enables to increase the effective pole angle (i.e. the circumferential length of each magnetic pole section) because all of the inner circumferential surfaces (in case the ring magnet unit 10 is fixed to the motor housing) are used for magnetic fields to the fullest, whereby the power of the electric motor is increased while keeping the same motor length. This arrangement can achieve an easy and inexpensive manner to provide efficient magnetic circuit.

Adjacent two magnetic fields can be abutting each other. However, gaps 13 (see FIG. 3B) can be arranged between adjacent two magnetic fields 11, 12.

The circumferential length of the at least one field of the north magnetic pole 11 and the at least one field of the south magnetic pole 12 can be same as but can also be different from the circumferential length of other fields. Furthermore, the at least one field of the north magnetic pole 11 is comprising at least two fields and the at least one field of the south magnetic pole 12 is comprising at least two fields and the circumferential length of the at least one gap 13 between the adjacent one field of the north magnetic pole 11 and one field of the south magnetic pole 12 can be the same, but can be different from the circumferential length of other gaps 13. These irregular arrangements can be used for the rotational detection.

As can be also seen in FIG. 3A, the at least one field of the north magnetic pole 11 and the at least one field of the south magnetic pole 12 comprise skewed magnetic fields. FIG. 3C and FIG. 3D show other examples of the skewed magnetic fields where the skewed magnetic fields are formed to be V-shape (FIG. 3C) or C-shape (FIG. 3D). In case the ring magnet unit 10 is fixed to a motor housing, due to skewed magnetic fields, the cogging torque of a motor is reduced because an inner rotor of a motor can move from one magnetic pole to the other magnetic pole in a step-by-step manner. The skew angles and shapes can be varied as required and/or desired.

As can be seen in FIG. 3E, at least one field of a north magnetic pole 11 and at least one field of a south magnetic pole 12 are arranged in the circumferential direction one after the other on the ring magnet unit. As can be seen in FIG. 3E, the at least one field of the north magnetic pole 11 and the at least one field of the south magnetic pole 12 can also comprise perpendicular magnetic fields.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A ring magnet unit for an electric motor, comprising:
a circular magnet holder; and
at least two magnet segments fixed to the magnet holder and arranged in a circumferential direction of the magnet holder, wherein respective one magnet segment has a first surface abutting to a surface of the magnet holder and a second surface, which is the opposite surface of the first surface, and both side surfaces of the first surface and the second surface are chamfered in the directions that cross the radial direction of the magnet holder at the same angles; characterized in that at least one pair of the adjacent two magnet segments are comprising one magnet segment whose circumferential length of the first surface is equal to or longer than the circumferential length of the second surface and the other magnet segment whose circumferential length of the first surface is equal to or shorter than the circumferential length of the second surface.

2. The ring magnet unit according to claim 1, wherein the side surfaces of the adjacent two magnet segments are abutting each other in the circumferential distance.

3. The ring magnet unit according to claim 1, wherein the both chamfered side surfaces have at least one stepping portion respectively.

4. The ring magnet unit according to claim 1, wherein at least one field of a north magnetic pole and at least one field of a south magnetic pole are arranged in the circumferential direction one after the other on the ring magnet unit.

5. The ring magnet unit according to claim 4, wherein the at least one field of the north magnetic pole and the at least one field of the south magnetic pole are respectively arranged on the ring magnet unit overlapping plural magnet segments.

6. The ring magnet unit according to claim 4, wherein the circumferential length of the at least one field of the north magnetic pole and the at least one field of the south magnetic pole are different from the circumferential length of other fields.

7. The ring magnet unit according to claim 4, wherein the at least one field of the north magnetic pole are comprising at least two fields and the at least one field of the south magnetic pole are comprising at least two fields and the circumferential length of the at least one gap between the adjacent one field of the north magnetic pole and one field of the south magnetic pole are different from the circumferential length of other gaps.

8. The ring magnet unit according to claim 4, wherein the at least one field of the north magnetic pole and the at least one field of the south magnetic pole comprise skewed magnetic fields.

9. The ring magnet unit according to claim 4, wherein the skewed magnetic fields are formed to be V-shape or C-shape.

10. The ring magnet unit according to claim 1, wherein the at least two magnet segments are fixed to an inner circumferential surface of the circular magnet holder.

11. The ring magnet unit according to claim 1, wherein the at least two magnet segments are fixed to an outer circumferential surface of the circular magnet holder.

12. An electric motor comprising a ring magnet unit according to claim 10.
